(19) United States
(12) Patent Application Publication
(10) Pub. No.: US 2024/0205621 A1
(43) Pub. Date: Jun. 20, 2024

(54) SYSTEM AND METHOD FOR BILATERAL BONE CONDUCTION COORDINATION AND BALANCING

(71) Applicant: Cochlear Limited, Macquarie University, New South Wales (AU)

(72) Inventors: Armin AZHIRNIAN, Mölnlycke (SE); Anders SKÖLD, Mölnlycke (SE)

(21) Appl. No.: 18/556,871

(22) PCT Filed: May 18, 2022
(86) PCT No.: PCT/IB2022/054643

§ 371 Date: Oct. 23, 2023

Related U.S. Application Data
(60) Provisional application No. 63/208,175, filed on Jun. 8, 2021.

(51) Int. Cl. H04R 25/00

(52) U.S. Cl. CPC H04R 25/606; H04R 25/554; H04R 2460/13

(57) ABSTRACT

An apparatus includes a first transducer configured to be in mechanical communication with a first location of a recipient's body and configured to generate and transmit first auditory vibrations to a first ear region of the recipient and a second transducer configured to be in mechanical communication with a second location spaced from the first location and configured to generate and transmit second auditory vibrations to a second ear region of the recipient. The apparatus further includes at least one processor configured to receive input signals indicative of audio data and configured to, in response to the input signals, generate and transmit first control signals to the first auditory transducer and second control signals to the second auditory transducer. The first and second control signals are indicative of the audio data and configured to inhibit destructive interference of the first auditory vibrations and the second auditory vibrations at the first ear region and/or at the second ear region within a range of vibrational frequencies.

### BACKGROUND

### Field

The present application relates generally to systems and methods for coordinating operation of two bone conduction transducers of a bilateral bone conduction auditory system to improve performance in a range of low auditory frequencies.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises a first transducer configured to be in mechanical communication with a first location of a recipient's body and configured to generate and transmit first auditory vibrations to a first ear region of the recipient. The apparatus further comprises a second transducer configured to be in mechanical communication with a second location spaced from the first location and configured to generate and transmit second auditory vibrations to a second ear region of the recipient. The apparatus further comprises at least one processor configured to receive input signals indicative of audio data and configured to, in response to the input signals, generate and transmit first control signals to the first auditory transducer and second control signals to the second auditory transducer. The first and second control signals are indicative of the audio data and configured to inhibit destructive interference of the first auditory vibrations and the second auditory vibrations at the first ear region and/or at the second ear region within a range of vibrational frequencies.

In another aspect disclosed herein, a method comprises receiving audio data from a sound source. The method further comprises generating, in response to the audio data, first control signals configured to control generation of first sound vibrations by a first transducer. The method further comprises generating, in response to the audio data, second control signals configured to control generation of second sound vibrations by a second transducer spaced from the first transducer. The method further comprises transmitting the first control signals to the first transducer. The method further comprises transmitting the second control signals to the second transducer. The method further comprises adjusting a gain and/or a phase of the first and/or second sound vibrations in a range of vibrational frequencies to adjust a sound magnitude and/or a sound source location perceived by a recipient of the first and second sound vibrations.

In another aspect disclosed herein, a non-transitory computer readable storage medium has stored thereon a computer program that instructs a computer system to adjust a transfer function of at least one bone conduction actuator of a bilateral bone conduction system by at least receiving audio data from a sound source. The computer program further instructs the computer system to generate, in response to the audio data, first control signals configured to control generation of first sound vibrations by a first bone conduction actuator. The computer program further instructs the computer system to generate, in response to the audio data, second control signals configured to control generation of second sound vibrations by a second bone conduction actuator spaced from the first bone conduction actuator. The computer program further instructs the computer system to transmit the first control signals to the first bone conduction actuator and to transmit the second control signals to the second bone conduction actuator. The computer program further instructs the computer system to adjust a gain and/or a phase of the first and/or second sound vibrations in a range of vibrational frequencies to adjust a sound magnitude and/or a sound source location perceived by a recipient of the first and second sound vibrations.

In another aspect disclosed herein, a method for fitting an example apparatus to a recipient comprises using two bone conduction transducers at two separate locations of the recipient's head to generate and transmit auditory vibrations concurrently to the recipient's two ears. The auditory vibrations are indicative of sound to be perceived by the recipient. The method further comprises adjusting a phase difference in a range of vibrational frequencies between the auditory vibrations from the two bone conduction transducers to increase loudness perceived by the recipient of the auditory vibrations in the range of vibrational frequencies. The method further comprises adjusting a gain in the range of vibrational frequencies of the auditory vibrations from at least one of the two bone conduction transducers so that the recipient perceives receiving the sound from a front spatial direction.

### BRIEF DESCRIPTION OF THE DRAWINGS

Implementations are described herein in conjunction with the accompanying drawings, in which:

FIG. 1A schematically illustrates a portion of an example transcutaneous bone conduction device implanted in a recipient in accordance with certain implementations described herein;

FIG. 1B schematically illustrate a portion of another example transcutaneous bone conduction device implanted in a recipient in accordance with certain implementations described herein;

FIGS. 2A and 2B schematically illustrate an example apparatus in accordance with certain implementations as described herein;

FIG. 3A is a plot of an example gain G(f) as a function of vibrational frequency (f) applied by an example band stop filter of the at least one processor to the first auditory vibrations in accordance with certain implementations described herein;

FIG. 3B is a plot of an example phase change Φ(f) as a function of vibrational frequency (f) applied by an example band all-pass filter of the at least one processor to the first auditory vibrations in accordance with certain implementations described herein;

FIG. 3C is a plot of an example gain G(f) as a function of vibrational frequency (f) applied by an example gain compensation circuitry of the at least one processor to the first auditory vibrations along with a phase change Φ(f) as a function of vibrational frequency (f) applied by an example band all-pass filter of the at least one processor to the first auditory vibrations in accordance with certain implementations described herein;

FIG. 4 is a flow diagram of an example method for fitting an example apparatus to a recipient in accordance with certain implementations described herein; and

FIG. 5 is a flow diagram of an example method in accordance with certain implementations described herein.

### DETAILED DESCRIPTION

Certain implementations described herein provide a system and method for addressing cross talk experienced by recipients of a bilateral bone actuated hearing prosthesis system by which vibration signals from a bone actuated hearing prosthesis device at the contralateral side of the recipient's head at least partially cancel out vibrational signals from a bone actuated hearing prosthesis device at the ipsilateral side of the recipient's head in a range of vibrational frequencies (e.g., at lower vibrational frequencies; bass). By adjusting the transfer function of at least one of the two devices (e.g., adjusting the phase and/or amplitude or gain of the vibrational signals from at least one of the two devices) in the predetermined vibrational frequency range, certain implementations increase the sound perceived by the recipient in the predetermined vibrational frequency range as compared either to a single device or to a bilateral device system in which the transfer function is not adjusted.

The teachings detailed herein are applicable, in at least some implementations, to any type of implantable or non-implantable vibration stimulation system or device (e.g., implantable or non-implantable bone conduction auditory prosthesis device or system). Implementations can include any type of medical device that can utilize the teachings detailed herein and/or variations thereof. Furthermore, while certain implementations are described herein in the context of auditory prosthesis devices, certain other implementations are compatible in the context of other types of devices or systems (e.g., bone conduction headphones; bone conduction speakers; bone conduction microphones; ultrasonic imaging).

Merely for ease of description, apparatus and methods disclosed herein are primarily described with reference to an illustrative medical system, namely a bilateral active transcutaneous bone conduction auditory prosthesis system. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from improvement of hearing percepts at lower vibrational frequency ranges of vibrations generated by an electromagnetic transducer. Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

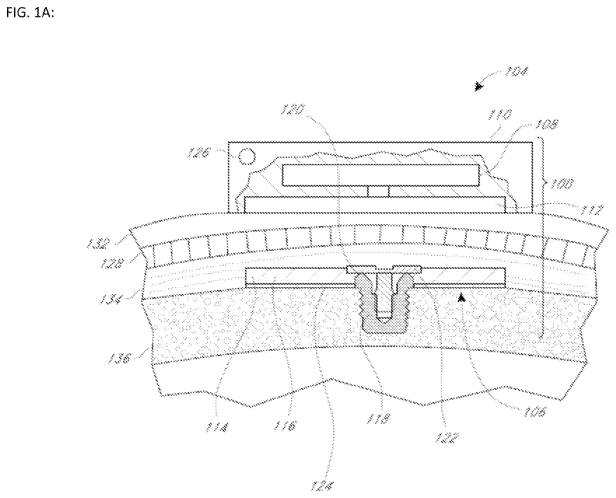

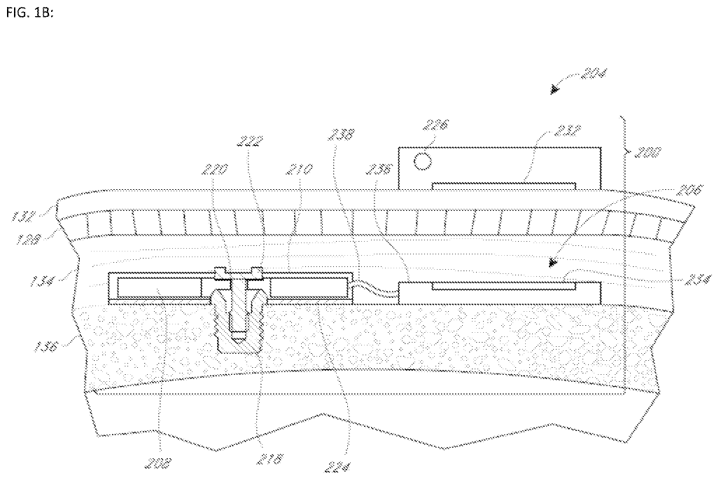

FIG. 1A schematically illustrates a portion of an example transcutaneous bone conduction device 100 implanted in a recipient in accordance with certain implementations described herein. FIG. 1B schematically illustrate a portion of another example transcutaneous bone conduction device 200 implanted in a recipient in accordance with certain implementations described herein.

The example transcutaneous bone conduction device 100 of FIG. 1A includes an external device 104 and an implantable component 106. The transcutaneous bone conduction device 100 of FIG. 1A is a passive transcutaneous bone conduction device in that a vibrating actuator 108 is located in the external device 104 and delivers vibrational stimuli through the skin 132 to the skull 136. The vibrating actuator 108 is located in a housing 110 of the external component 104 and is coupled to a plate 112. The plate 112 can be in the form of a permanent magnet and/or in another form that generates and/or is reactive to a magnetic field, or otherwise permits the establishment of magnetic attraction between the external device 104 and the implantable component 106 sufficient to hold the external device 104 against the skin 132 of the recipient.

In certain implementations, the vibrating actuator 108 is a device that converts electrical signals into vibration. In operation, a sound input element 126 can convert sound into electrical signals. Specifically, the transcutaneous bone conduction device 100 can provide these electrical signals to the vibrating actuator 108, or to a sound processor (not shown) that processes the electrical signals, and then provides those processed signals to the vibrating actuator 108. The vibrating actuator 108 can convert the electrical signals (processed or unprocessed) into vibrations. Because the vibrating actuator 108 is mechanically coupled to the plate 112, the vibrations are transferred from the vibrating actuator 108 to the plate 112. The implanted plate assembly 114 is part of the implantable component 106 and is made of a ferromagnetic material that may be in the form of a permanent magnet, that generates and/or is reactive to a magnetic field, or otherwise permits the establishment of a magnetic attraction between the external device 104 and the implantable component 106 sufficient to hold the external device 104 against the skin 132 of the recipient. Accordingly, vibrations produced by the vibrating actuator 108 of the external device 104 are transferred from the plate 112 across the skin 132 to a plate 116 of the plate assembly 114. This can be accomplished as a result of mechanical conduction of the vibrations through the skin 132, resulting from the external device 104 being in direct contact with the skin 132 and/or from the magnetic field between the two plates 112, 116. These vibrations are transferred without a component penetrating the skin 132, fat 128, or muscular 134 layers on the head.

In certain implementations, the implanted plate assembly 114 is substantially rigidly attached to a bone fixture 118. The implantable plate assembly 114 can include a through hole 120 that is contoured to the outer contours of the bone fixture 118. This through hole 120 thus forms a bone fixture interface section that is contoured to the exposed section of the bone fixture 118. In certain implementations, the sections are sized and dimensioned such that at least a slip fit or an interference fit exists with respect to the sections. A screw 122 can be used to secure the plate assembly 114 to the bone fixture 118. In certain implementations, a silicone layer 124 is located between the plate 116 and the bone 136 of the skull.

As can be seen in FIG. 1A, the head of the screw 122 is larger than the hole through the implantable plate assembly 114, and thus the screw 122 positively retains the implantable plate assembly 114 to the bone fixture 118. The portions of the screw 122 that interface with the bone fixture 118 substantially correspond to an abutment screw, thus permitting the screw 122 to readily fit into an existing bone fixture used in a percutaneous bone conduction device. In certain implementations, the screw 122 is configured so that the same tools and procedures that are used to install and/or remove an abutment screw from the bone fixture 118 can be used to install and/or remove the screw 122 from the bone fixture 118.

As schematically illustrated by FIG. 1B, an example transcutaneous bone conduction device 200 comprises an external device 204 and an implantable component 206. The device 200 is an active transcutaneous bone conduction device in that the vibrating actuator 208 is located in the implantable component 206. For example, a vibratory element in the form of a vibrating actuator 208 is located in a housing 210 of the implantable component 206. In certain implementations, much like the vibrating actuator 108 described herein with respect to the transcutaneous bone conduction device 100, the vibrating actuator 208 is a device that converts electrical signals into vibration. The vibrating actuator 208 can be in direct contact with the outer surface of the recipient's skull 136 (e.g., the vibrating actuator 208 is in substantial contact with the recipient's bone 136 such that vibration forces from the vibrating actuator 208 are communicated from the vibrating actuator 208 to the recipient's bone 136). In certain implementations, there can be one or more thin non-bone tissue layers (e.g., a silicone layer 224) between the vibrating actuator 208 and the recipient's bone 136 (e.g., bone tissue) while still permitting sufficient support so as to allow efficient communication of the vibration forces generated by the vibrating actuator 208 to the recipient's bone 136.

In certain implementations, the external component 204 includes a sound input element 226 that converts sound into electrical signals. Specifically, the device 200 provides these electrical signals to the vibrating actuator 208, or to a sound processor (not shown) that processes the electrical signals, and then provides those processed signals to the implantable component 206 through the skin of the recipient via a magnetic inductance link. For example, a transmitter coil 232 of the external component 204 can transmit these signals to an implanted receiver coil 234 located in a housing 236 of the implantable component 206. Components (not shown) in the housing 236, such as, for example, a signal generator or an implanted sound processor, then generate electrical signals to be delivered to the vibrating actuator 208 via electrical lead assembly 238. The vibrating actuator 208 converts the electrical signals into vibrations. In certain implementations, the vibrating actuator 208 can be positioned with such proximity to the housing 236 that the electrical leads 238 are not present (e.g., the housing 210 and the housing 238 are the same single housing containing the vibrating actuator 208, the receiver coil 234, and other components, such as, for example, a signal generator or a sound processor).

In certain implementations, the vibrating actuator 208 is mechanically coupled to the housing 210. The housing 210 and the vibrating actuator 208 collectively form a vibrating element. The housing 210 can be substantially rigidly attached to a bone fixture 218. In this regard, the housing 210 can include a through hole 220 that is contoured to the outer contours of the bone fixture 218. The screw 222 can be used to secure the housing 210 to the bone fixture 218. As can be seen in FIG. 1B, the head of the screw 222 is larger than the through hole 220 of the housing 210, and thus the screw 222 positively retains the housing 210 to the bone fixture 218. The portions of the screw 222 that interface with the bone fixture 218 substantially correspond to the abutment screw detailed below, thus permitting the screw 222 to readily fit into an existing bone fixture used in a percutaneous bone conduction device (or an existing passive bone conduction device). In certain implementations, the screw 222 is configured so that the same tools and procedures that are used to install and/or remove an abutment screw from the bone fixture 218 can be used to install and/or remove the screw 222 from the bone fixture 218.

The example transcutaneous bone conduction auditory device 100 of FIG. 1A comprises an external sound input element 126 (e.g., external microphone) and the example transcutaneous bone conduction auditory device 200 of FIG. 1B comprises an external sound input element 226 (e.g., external microphone). Other example auditory devices (e.g., totally implantable transcutaneous bone conduction devices) in accordance with certain implementations described herein can replace the external sound input element 126, 226 with a subcutaneously implantable sound input assembly (e.g., implanted microphone).

In certain implementations, a recipient wears or has implanted two bone conduction auditory devices (e.g., two devices 100; two devices 200; one device 100 and one device 200) at substantially opposite sides of the recipient's skull 136 (e.g., a bilateral bone conduction auditory system), each device 100, 200 of the bilateral system configured to generate auditory vibrations and to provide the auditory vibrations via bone conduction to a corresponding ear of the recipient. As used herein, the phrase “auditory vibrations” has its broadest reasonable meaning, including vibrations within a range of vibrational frequencies that are perceptible by the recipient as sound (e.g., a range of 20 Hz to 20 kHz).

For auditory vibrations in certain ranges of vibrational frequencies, the recipient can experience cross-talk among the two devices 100, 200 of the bilateral system (e.g., vibrations from the device 100, 200 on the contralateral side of the recipient's head at least partially interfering with vibrations from the device 100, 200 on the ipsilateral side of the recipient's head) due to the rigid-body nature of the human head at vibrational frequencies below 600 Hz (see, e.g., N. Kim et al., “A Three-Dimensional Finite-Element Model of a Human Dry Skull for Bone-Conduction Hearing,” BioMed Research International, 9 pages http://dx.doi.org/10.1155/2014/519429 (2014)). For example, at vibrational frequencies of about 100 Hz, the auditory vibrations from the device 100, 200 on the contralateral side can be in phase with the auditory vibrations from the device 100, 200 on the ipsilateral side of the recipient's head, while at vibrational frequencies of about 600 Hz, the auditory vibrations from the device 100, 200 on the contralateral side can be in out of phase with the auditory vibrations from the device 100, 200 on the ipsilateral side of the recipient's head. At some vibrational frequencies, such cross-talk can substantially cancel out the auditory vibrations from the ipsilateral device 100, 200, resulting in overall reduction of the sound perceived by the recipient in the low frequency regime (e.g., less bass heard by the recipient). Recognizing the faulty assumption that two devices 100, 200 of a bilateral system are louder than one device 100, 200, certain implementations described herein adjust the operation of one or both devices 100, 200 (e.g., for at least one of the devices, adjusting a transfer function of the output vibrational signals relative to the input audio data, adjusting the transfer function including adjusting the phase and/or amplitude of the output vibrational signals) to reduce the effects of cross-talk interference and to improve the performance of the bilateral system in certain ranges of auditory vibrations. By adjusting the transfer function in the range of auditory vibrations, certain implementations described herein increase the sound perceived by the recipient for the same voltage range provided to the devices, which can increase the range of auditory vibrations for fitting and/or increasing battery life of the devices.

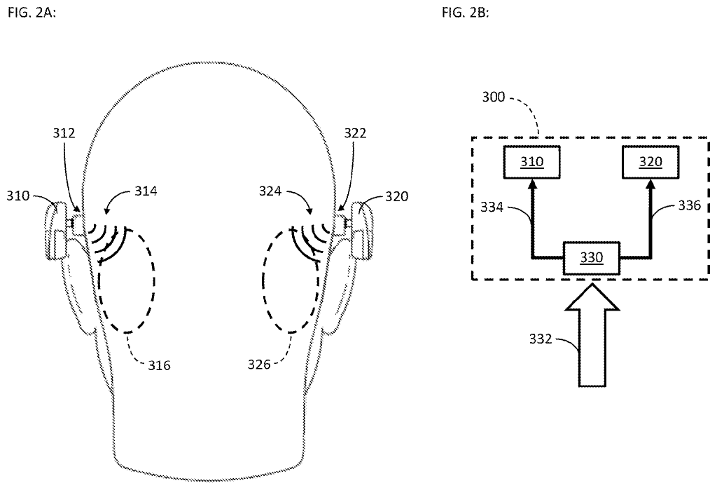

FIGS. 2A and 2B schematically illustrate an example apparatus 300 in accordance with certain implementations as described herein. The apparatus 300 comprises a first transducer 310 configured to be in mechanical communication with a first location 312 of a recipient's body and configured to generate and transmit first auditory vibrations 314 to a first ear region 316 of the recipient. The apparatus 300 further comprises a second transducer 320 configured to be in mechanical communication with a second location 322 spaced from the first location 312 and configured to generate and transmit second auditory vibrations 324 to a second ear region 326 of the recipient. The apparatus 300 further comprises at least one processor 330 configured to receive input signals 332 indicative of audio data and configured to, in response to the input signals 332, generate and transmit first control signals 334 to the first transducer 310 and second control signals 336 to the second transducer, the first and second control signals 334, 336 indicative of the audio data and configured to inhibit destructive interference of the first auditory vibrations 314 and the second auditory vibrations 324 at the first ear region 316 and/or at the second ear region 326 within a range of vibrational frequencies.

In certain implementations, the first transducer 310 comprises a first bone conduction transducer worn by the recipient or implanted on and/or within the recipient's body at the first location 312 and the second transducer 320 comprises a second bone conduction transducer worn by the recipient or implanted on and/or within the recipient's body at the second location 322. For example, the first transducer 310 can comprise a first actuator 108, 208 of a first bone conduction auditory device 100, 200 in mechanical communication with a first bone fixture 118, 218 affixed to the skull 136 at a first location 312 and the second transducer 320 can comprise a second actuator 108, 208 of a second bone conduction auditory device 100, 200 in mechanical communication with a second bone fixture 118, 218 affixed to the skull 136 at a second location 322. For another example, the first transducer 310 and/or the second transducer 320 can comprise a bone conduction headphone speaker configured to be worn by the recipient at a corresponding location 312, 322 on a corresponding side of the recipient's head and to generate and transmit auditory vibrations to be detected by the ipsilateral ear of the recipient as sound.

In certain implementations, the first location 312 is closer to a first ear of the recipient's body (e.g., the first ear region 316) than to a second ear of the recipient's body (e.g., the second ear region 326) and the second location 322 is closer to the second ear than to the first ear. For example, the first transducer 310, first location 312, and first ear region 316 can be on the left side of the recipient's head and the second transducer 320, second location 322, and second ear region 326 can be on the right side of the recipient's head (see, FIG. 2A), or the first transducer 310, first location 312, and first ear region 316 can be on the right side of the recipient's head and the second transducer 320, second location 322, and second ear region 326 can be on the left side of the recipient's head.

In certain implementations, the first ear region 316 comprises an inner ear region and/or a middle ear region and the second ear region 326 comprises an inner ear region and/or a middle ear region. The middle ear region can comprise a region within the recipient's head, partially bounded by the tympanic membrane and comprising the ossicles (e.g., malleus; incus; stapes), the round window, the oval window, and the Eustachian tube. The inner ear region can comprise a region within the recipient's head (e.g., within the temporal bone) and comprising the vestibule, the cochlea, and the semicircular canals. A first portion of the first auditory vibrations 314 are received by the first ear region 316 (e.g., the ipsilateral ear to the first transducer 310; the inner ear region and/or the middle ear region of the recipient's ear proximal to the first transducer 310) while a second portion of the first auditory vibrations 314 are received by the second ear region 326 (e.g., the contralateral ear to the first transducer 310; the inner ear region and/or the middle ear region of the recipient's ear distal from the first transducer 310). A first portion of the second auditory vibrations 324 are received by the second ear region 326 (e.g., the ipsilateral ear to the second transducer 320; the inner ear region and/or the middle ear region of the recipient's ear proximal to the second transducer 320) while a second portion of the second auditory vibrations 324 are received by the first ear region 316 (e.g., the contralateral ear to the second transducer 320; the inner ear region and/or the middle ear region of the recipient's ear distal from the second transducer 320).

In certain implementations, the at least one processor 330 comprises a single processor (e.g., microelectronic circuitry; application-specific integrated circuit; generalized integrated circuits programmed by software with computer executable instructions; sound processor; digital signal processor; analog signal processor) in operative communication with both the first transducer 310 and with the second transducer 320. For example, the single processor can be within a housing that also contains the first transducer 310 (e.g., the single processor can transmit the first control signals 334 to the first transducer 310 via wired communications and can transmit the second control signals 336 to the second transducer 320 via wireless communications). For another example, the single processor can be within a housing (e.g., the housing of an external device worn, held, and/or carried by the recipient) that is separate from the housings that contain the first transducer 310 and the second transducer 320 (e.g., the single processor can transmit the first control signals 334 to the first transducer 310 and the second control signals 336 to the second transducer 320 via wireless communications).

In certain other implementations, the at least one processor 330 comprises a first processor (e.g., microelectronic circuitry; application-specific integrated circuit; generalized integrated circuits programmed by software with computer executable instructions; sound processor; digital signal processor; analog signal processor) in operative communication with the first transducer 310 and a second processor (e.g., microelectronic circuitry; application-specific integrated circuit; generalized integrated circuits programmed by software with computer executable instructions; sound processor; digital signal processor; analog signal processor) in operative communication with the second transducer, the first processor and the second processor in operative communication with one another (e.g., with one of the first and second processors transmitting control instructions to the other of the first and second processors). For example, the first processor can be within a housing that also contains the first transducer 310 (e.g., the first processor can transmit the first control signals 334 to the first transducer 310 via wired communications and can be in wireless communication with the second processor) and the second processor can be within a housing that also contains the second transducer 320 (e.g., the second processor can transmit the second control signals 336 to the second transducer 320 via wired communications and can be in wireless communication with the first processor).

In certain implementations, the at least one processor 330 is configured to receive input signals 332 indicative of audio data. For example, the input signals 332 can be generated by at least one microphone (e.g., external to the recipient's body; implanted on or within the recipient's body). The at least one microphone can be configured to respond to received sound from the ambient environment by generating the input signals 332 comprising audio data indicative of the received sound and to transmit the input signals 332 (e.g., via wired communication; via wireless communication) to the at least one processor 330. For another example, the input signals 332 can be indicative of audio data of media content being watched and/or listened to by the recipient. The input signals 332 can be generated and transmitted to the at least one processor 330 wirelessly (e.g., WiFi; Bluetooth; cellphone connection, telephony, or other Internet connection) by a remote broadcast system and/or a media player (e.g., smart phone, smart tablet, smart watch, radio, laptop computer, or other mobile computing device; television; desktop computer, or other non-mobile media player used, worn, held, and/or carried by the recipient). In certain implementations, the at least one processor 330 is further configured to receive user input from the recipient via an input device (e.g., keyboard; touchscreen; buttons; switches; voice recognition system) and to respond to the user input by controlling the apparatus 300.

In certain implementations, the at least one processor 330 comprises and/or is in operative communication with at least one storage device configured to store information (e.g., data; commands) accessed by the at least one processor 330 during operation (e.g., while providing the functionality of certain implementations described herein). The at least one storage device can comprise at least one tangible (e.g., non-transitory) computer readable storage medium, examples of which include but are not limited to: read only memory (ROM); random access memory (RAM); magnetic disk storage media; optical storage media; flash memory. The at least one storage device can be encoded with software (e.g., a computer program downloaded as an application) comprising computer executable instructions for instructing the at least one processor 330 (e.g., executable data access logic, evaluation logic, and/or information outputting logic). In certain implementations, the at least one processor 330 executes the instructions of the software to provide functionality as described herein.

In certain implementations, the at least one processor 330 is configured to operate in at least two modes: a first (e.g., “normal”) operation mode in which the functionalities described herein are disabled and a second (e.g., “smart”) operation mode in which the functionalities described herein are enabled. For example, the at least one processor 330 can switch between the first and second modes in response to user input (e.g., indicating that the user seeks the functionalities described herein) and/or automatically (e.g., based on detected characteristics of the audio data of the input signals 332).

In certain implementations, the at least one processor 330 is configured to respond to the audio data of the input signals 332 by generating the first and second control signals 334, 336. The first control signals 334 are indicative of the portion of the audio data corresponding to sounds to be perceived via the first ear region 316 and the second control signals 336 are indicative of the portion of the audio data corresponding to sounds to be perceived via the second ear region 326. The first and/or second control signals 334, 336 are configured to control the operation of the first and/or second transducers 310, 320, respectively, so as to adjust (e.g., modify; improve; optimize) one or more parameters (e.g., magnitude; phase) of the first and/or second auditory vibrations 314, 324. For example, the first and second control signals 334, 336 can be configured to adjust a gain and/or a phase applied to the first and/or second auditory vibrations 314, 324 to inhibit (e.g., avoid) destructive interference of the first auditory vibrations 314 and the second auditory vibrations 324 at the first ear region 316 and/or at the second ear region 326 within a range of vibrational frequencies.

In certain implementations, the at least one processor 330 is configured to inhibit the auditory vibrations from one of the first and second transducers 310, 320 in a range of vibrational frequencies while not inhibiting the auditory vibrations in the range of vibrational frequencies from the other of the first and second transducers 310, 320 (e.g., inhibiting the first auditory vibrations 314 in the range of vibrational frequencies while not inhibiting the second auditory vibrations 324 in the range of vibrational frequencies). In this way, the apparatus 300 can inhibit (e.g., avoid) destructive interference between the first and second auditory vibrations 314, 324 at the first ear region 316 and/or the second ear region 326.

For example, only one of the first and second transducers 310, 320 can be configured to generate auditory vibrations in the bass (e.g., low frequency range susceptible to being affected by destructive interference between the first and second auditory vibrations 314, 324). As a result of not being configured to generate bass auditory vibrations, the other of the first and second transducers 310, 320 can be made smaller and/or can have longer battery life (e.g., due to the power savings from not generating low frequency auditory vibrations), as compared to the one of the first and second transducers 310, 320 configured to generate bass auditory vibrations.

For another example, the at least one processor 330 can be configured to turn off the bass (e.g., low frequency range) of one of the first and second transducers 310, 320 while leaving the bass of the other of the first and second transducers 310, 320 unaffected. In certain implementations, the at least one processor 330 selects which of the first transducers 310, 320 to have the bass turned off. For example, the at least one processor 330 can turn off the bass of the smaller of the first and second transducers 310, 320. For another example, the at least one processor 330 can turn off the bass of the one of the first and second transducers 310, 320 on the side of the recipient's head more affected by an article (e.g., hat; helmet) being worn by the recipient. For another example, the at least one processor 330 can turn of the bass of the one of the first and second transducers 310, 320 that results in more auditory feedback (e.g., estimated feedback; actual feedback experienced by the recipient). In certain implementations, the at least one processor 330 multiplexes the first and second transducers 310, 320 by alternately and repeatedly turning off the bass of the first transducer 310 while the bass of the second transducer 320 is remains on, then turning on the bass of the first transducer 310 while the bass of the second transducer 320 is turned off. While turning off the bass of one of the first and second transducers 310, 320 can result in some loss of directional information perceived by the recipient (e.g., spatial imbalance), such effects in the bass frequency range are small. In certain implementations, the output perceived by the recipient in the first range of vibrational frequencies when the bass of one of the first and second transducers 310, 320 is turned off can be increased by at least 6 dB as compared to when the bass of neither of the first and second transducers 310, 320 is turned off.

In certain implementations, the at least one processor 330 comprises a band stop filter (e.g., band stop filter circuitry) configured to inhibit the auditory vibrations from one of the first and second transducers 310, 320 in a range of vibrational frequencies while not inhibiting the auditory vibrations from the other of the first and second transducers 310, 320 in the range of vibrational frequencies (e.g., inhibiting the first auditory vibrations 314 in the range of vibrational frequencies while not inhibiting the second auditory vibrations 324 in the range of vibrational frequencies). For example, in response to generating the first control signals 334 using the band stop filter and generating the second control signals 336 without using the band stop filter, the magnitude of the first auditory vibrations 314 from the first transducer 310 can be substantially equal to zero in the range of vibrational frequencies while the magnitude of the second auditory vibrations 324 from the second transducer 320 correspond to the sounds to be perceived in the range of vibrational frequencies in the audio data. In certain implementations, the range of vibrational frequencies is from a first frequency to a second frequency, the first frequency greater than or equal to zero and the second frequency greater than or equal to 200 Hz and less than or equal to 2 kHz.

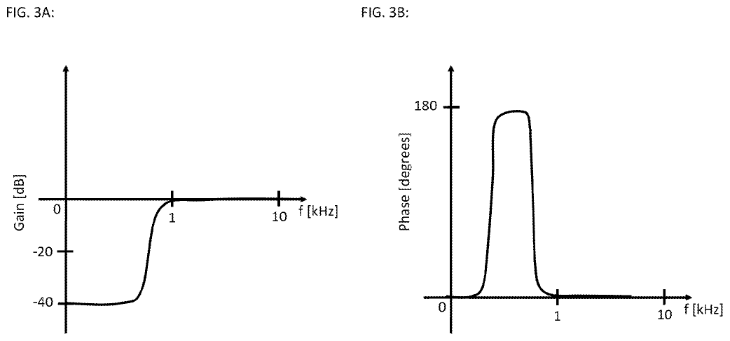

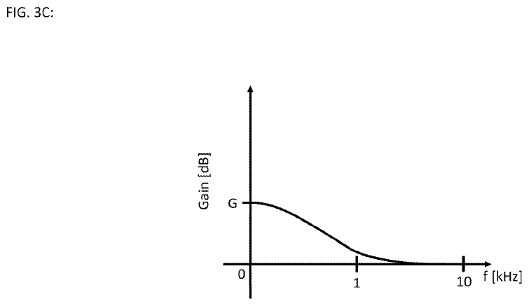

FIG. 3A is a plot of an example gain G(f) as a function of vibrational frequency (f) applied by an example band stop filter of the at least one processor 330 to the first auditory vibrations 314 in accordance with certain implementations described herein. The gain G(f) of certain implementations has a large, negative value (e.g., −40 dB) for a first range of vibrational frequencies (e.g., from zero to 2 kHz; zero to 1 kHz; zero to 700 Hz; 200 Hz to 2 kHz; 200 Hz to 1 kHz; 200 Hz to 700 Hz) and a value of zero for a second range of vibrational frequencies above the first range of vibrational frequencies and/or for a third range of vibrational frequencies below the first range of vibrational frequencies (e.g., in a range of zero to 200 Hz). In certain implementations, the gain G(f) has a slope (dG/df) that has a peak at a vibrational frequency between the first and second ranges of vibrational frequencies (e.g., 700 Hz; 1 kHz; 2 kHz) and having a full-width-at-half-maximum in a range of zero to 200 Hz. In response to the first control signals 334 generated using the gain G(f) shown in FIG. 3A, the magnitude of the first auditory vibrations 314 is substantially equal to zero within the first range of vibrational frequencies (e.g., from zero to about 700 Hz.

In certain implementations, the at least one processor 330 is configured to adjust the phase of the auditory vibrations from one of the first and second transducers 310, 320 in a range of vibrational frequencies while not adjusting the phase of the auditory vibrations in the range of vibrational frequencies from the other of the first and second transducers 310, 320 (e.g., adjusting the phase of the first auditory vibrations 314 in the range of vibrational frequencies while not adjusting the phase of the second auditory vibrations 324 in the range of vibrational frequencies). In this way, the apparatus 300 can inhibit (e.g., avoid) destructive interference between the first and second auditory vibrations 314, 324 at the first ear region 316 and/or the second ear region 326. For example, the phase of the first auditory vibrations 314 relative to the phase of the second auditory vibrations 324 can be adjusted (e.g., inverted; changed by 180 degrees) to create constructive interference between the first and second auditory vibrations 314, 324 at the first ear region 316 and/or the second ear region 326. As a result of the constructive interference, the output of the apparatus 300 perceived by the recipient in the range of vibrational frequencies can be increased and/or can have longer battery life (e.g., due to the increased efficiency from improving the low frequency output). Adjusting the phase of the bass (e.g., below 800 Hz) of one of the first and second transducers 310, 320 may result in some loss of directional information perceived by the recipient (e.g., spatial imbalance), but such effects can be ameliorated by tuning (e.g., fitting) of the apparatus 300 to the recipient. In certain implementations, the output perceived by the recipient in the first range of vibrational frequencies when the bass of one of the first and second transducers 310, 320 has the phase inverted can be increased by at least 6 dB as compared to when the bass of neither of the first and second transducers 310, 320 has the phase inverted.

In certain implementations, the at least one processor 330 comprises a band all-pass filter configured to adjust (e.g., invert; change by 180 degrees) a phase of the first auditory vibrations 314 in the range of vibrational frequencies while not adjusting (e.g., not inverting; not changing) a phase of the second auditory vibrations 324 in the range of vibrational frequencies. For example, the at least one processor 330 can be configured to adjust (e.g., invert; change by 180 degrees) the phase in the bass (e.g., low frequency range) of one of the first and second transducers 310, 320 while leaving the phase in the bass of the other of the first and second transducers 310, 320 unaffected. In certain implementations, the range of vibrational frequencies is from a first frequency to a second frequency, the first frequency greater than or equal to zero and the second frequency greater than or equal to 200 Hz and less than or equal to 2 kHz. In response to generating the first control signals 334 using the band all-pass filter and generating the second control signals 336 without using the band all-pass filter, the phase of the first auditory vibrations 314 from the first transducer 310 can be substantially inverted in the range of vibrational frequencies while the phase of the second auditory vibrations 324 from the second transducer 320 correspond to the phase in the range of vibrational frequencies in the audio data.

FIG. 3B is a plot of an example phase change Φ(f) as a function of vibrational frequency (f) applied by an example band all-pass filter of the at least one processor 330 to the first auditory vibrations 314 in accordance with certain implementations described herein. The phase change Φ(f) of certain implementations has a large, positive value (e.g., 180 degrees) for a first range of vibrational frequencies (e.g., from zero to 2 kHz; zero to 1 kHz; zero to 700 Hz; 200 Hz to 2 kHz; 200 Hz to 1 kHz; 200 Hz to 700 Hz) and a value of zero for a second range of vibrational frequencies above the first range of vibrational frequencies and/or for a third range of vibrational frequencies below the first range of vibrational frequencies. In certain implementations, the phase change Φ(f) has a slope (dΦ/df) that has a first peak at a vibrational frequency between the first and second ranges of vibrational frequencies (e.g., 700 Hz; 1 kHz; 2 kHz) and having a full-width-at-half-maximum in a range of zero to 200 Hz. In certain implementations, the slope (dΦ/df) has a second peak at a vibrational frequency between the first and third ranges of vibrational frequencies (e.g., 100 Hz; 200 Hz) and having a full-width-at-half-maximum in a range of zero to 200 Hz. In response to the first control signals 334 generated using the phase change Φ(f) shown in FIG. 3B, the phase of the first auditory vibrations 314 is substantially inverted by 180 degrees within the first range of vibrational frequencies (e.g., from 200 Hz to about 700 Hz).

In certain implementations, the at least one processor 330 comprises the band all-pass filter as described herein and gain compensation circuitry (e.g., digital; analog) configured to adjust a first gain of the first auditory vibrations 314 in the range of vibrational frequencies and/or a second gain of the second auditory vibrations 324 in the range of vibrational frequencies. FIG. 3C is a plot of an example gain G(f) as a function of vibrational frequency (f) applied by an example gain compensation circuitry of the at least one processor 330 to the first auditory vibrations 314 along with a phase change Φ(f) as a function of vibrational frequency (f) applied by an example band all-pass filter of the at least one processor 330 to the first auditory vibrations 314 (e.g., see FIG. 3B) in accordance with certain implementations described herein. The gain G(f) of certain implementations has a positive value (e.g., in a range of 2 dB to 6 dB) for a first range of vibrational frequencies (e.g., from zero to 2 kHz; zero to 1 kHz; zero to 700 Hz; 200 Hz to 2 kHz; 200 Hz to 1 kHz; 200 Hz to 700 Hz) and a value of zero for a second range of vibrational frequencies above the first range of vibrational frequencies and/or for a third range of vibrational frequencies below the first range of vibrational frequencies (e.g., in a range of zero to 200 Hz). In certain implementations, the gain G(f) has a slope (dG/df) that has a peak at a vibrational frequency between the first and second ranges of vibrational frequencies (e.g., 700 Hz; 1 kHz; 2 kHz) and having a full-width-at-half-maximum in a range of zero to 800 Hz. In certain implementations, the gain G(f) applied by the gain compensation circuitry is configured to at least partially counteract (e.g., restore) a loss (e.g., degradation) of spatial balance perceived by the recipient from the phase change Φ(f) alone. In certain implementations, the gain G(f) is prescribed (e.g., factory-set) without the apparatus 300 being fitted to the recipient, while in certain other implementations, the gain G(f) is adjusted (e.g., tuned) during fitting of the apparatus 300 to the recipient.

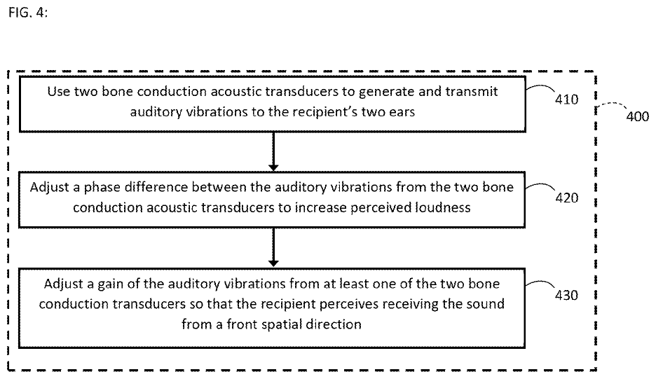

FIG. 4 is a flow diagram of an example method 400 for fitting an example apparatus 300 to a recipient in accordance with certain implementations described herein. While the method 400 is described by referring to some of the structures of the example apparatus 300 of FIGS. 2A-2B, other apparatus and systems with other configurations of components can also be used to perform the method 400 in accordance with certain implementations described herein. In certain implementations, a non-transitory computer readable storage medium has stored thereon a computer program that instructs a computer system to perform the method 400.

In an operational block 410, the method 400 comprises using two bone conduction transducers (e.g., first and second transducers 310, 320) at two separate locations (e.g., first and second locations 312, 322) of the recipient's head to generate and transmit auditory vibrations (e.g., first and second auditory vibrations 314, 324) concurrently to the recipient's two ears (e.g., first and second ear regions 316, 326), the auditory vibrations indicative of sound (e.g., indicative of speech), the recipient perceiving the auditory vibrations as the sound. In an operational block 420, the method 400 further comprises adjusting a phase difference in a range of vibrational frequencies between the auditory vibrations from the two bone conduction transducers to increase (e.g., maximize) loudness perceived by the recipient of the auditory vibrations in the range of vibrational frequencies. In an operational block 430, the method further comprises adjusting a gain in the range of vibrational frequencies of the auditory vibrations from at least one of the two bone conduction transducers so that the recipient perceives receiving the sound from a front spatial direction. For example, the method 400 can be used to counteract an asymmetry in the hearing by the recipient's two ears. For another example, the method 400 can be used to reduce feedback perceived by the recipient (e.g., by lowering the gain on the one of the two bone conduction transducers that generates more perceived feedback than the other bone conduction transducer). For another example, the method 400 can be used to optimize for loudness of the perceived sound or for the centeredness of the perceived sound.

In certain implementations, system performance using the two bone conduction transducers as compared to a single bone conduction transducer can be assessed using pure tone audiometry or synchronized wide band signals. For example, the two bone conduction transducers can be used concurrently to generate and transmit auditory vibrations (e.g., indicative of at least one substantially pure tone) and the loudness and/or spatial balance of the sound perceived by the recipient can be compared to the loudness and/or spatial balance of the sound perceived by the recipient when only a single bone conduction transducer is used to generate and transmit auditory vibrations. In certain implementations, the spatial balance perceived by the recipient can be adjusted using synchronized wide band signals.

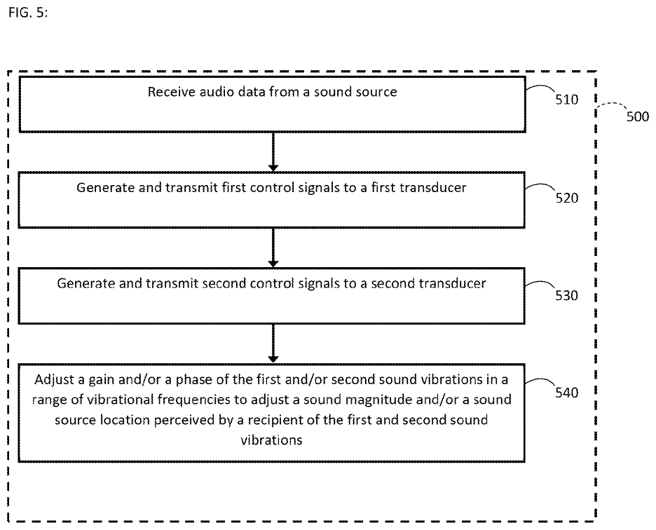

FIG. 5 is a flow diagram of an example method 500 in accordance with certain implementations described herein. While the method 500 is described by referring to some of the structures of the example apparatus 300 of FIGS. 2A-2B, other apparatus and systems with other configurations of components can also be used to perform the method 500 in accordance with certain implementations described herein. In certain implementations, a non-transitory computer readable storage medium has stored thereon a computer program that instructs a computer system to perform the method 500.

In an operational block 510, the method 500 comprises receiving audio data (e.g., via wired communication; via wireless communication) from a sound source. For example, the sound source can comprise at least one microphone configured to respond to received sound from the ambient environment by generating the audio data indicative of the received sound to the at least one processor 330. For another example, the sound source can comprise a media player being watched and/or listened to by the recipient.

In an operational block 520, the method 500 further comprises generating, in response to the audio data, first control signals configured to control generation of first sound vibrations by a first transducer and transmitting the first control signals to the first transducer. For example, the first transducer 310 can comprise a bone conduction actuator configured to be in mechanical communication with a first location 312 of a recipient's body (e.g., the first location 312 closer to a first ear 316 of the recipient's body than to a second ear 326 of the recipient's body).

In an operational block 530, the method 500 further comprises generating, in response to the audio data, second control signals configured to control generation of second sound vibrations by a second transducer spaced from the first transducer and transmitting the second control signals to the second transducer. For example, the second transducer 320 can comprise a bone conduction actuator configured to be in mechanical communication with a second location 322 of the recipient's body (e.g., the second location 322 closer to the second ear 326 than to the first ear 316).

In an operational block 540, the method 500 further comprises adjusting a gain and/or a phase of the first and/or second sound vibrations in a range of vibrational frequencies to adjust a sound magnitude and/or a sound source location perceived by a recipient of the first and second sound vibrations. The range of vibrational frequencies can be from a first frequency (e.g., greater than or equal to zero) to a second frequency (e.g., greater than or equal to 200 Hz and less than or equal to 2 kHz). In certain implementations, said adjusting comprises reducing a gain of the first sound vibrations in the range of vibrational frequencies (e.g., reducing the gain of the first sound vibrations to zero across the range of vibrational frequencies; not adjusting the gain of the second sound vibrations in the range of vibrational frequencies). In certain implementations, said adjusting comprises adjusting a phase of the first sound vibrations in the range of vibrational frequencies (e.g., inverting the phase of the first sound vibrations in the range of vibrational frequencies). In certain implementations in which the first transducer and the second transducer are components of a bilateral bone conduction auditory prosthesis worn and/or implanted on and/or within the recipient's body, said adjusting is performed during a fitting procedure of the bilateral bone conduction auditory prosthesis to the recipient.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of various devices, various implementations described herein can be incorporated in a variety of other suitable devices, methods, and contexts. More generally, as can be appreciated, certain implementations described herein can be used in a variety of implantable medical device contexts that can benefit from certain attributes described herein.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein but should be defined only in accordance with the claims and their equivalents.

1. An apparatus comprising:
a first transducer configured to be in mechanical communication with a first location of a recipient's body and configured to generate and transmit first auditory vibrations to a first ear region of the recipient;
a second transducer configured to be in mechanical communication with a second location spaced from the first location and configured to generate and transmit second auditory vibrations to a second ear region of the recipient; and
at least one processor configured to receive input signals indicative of audio data and configured to, in response to the input signals, generate and transmit first control signals to the first auditory transducer and second control signals to the second auditory transducer, the first and second control signals indicative of the audio data and configured to inhibit destructive interference of the first auditory vibrations and the second auditory vibrations at the first ear region and/or at the second ear region within a range of vibrational frequencies.

2. The apparatus of claim 1, wherein the first ear region comprises an inner ear region and/or a middle ear region and the second ear region comprises an inner ear region and/or a middle ear region.

3. The apparatus of claim 1, wherein the first transducer comprises a first bone conduction transducer worn by the recipient or implanted on and/or within the recipient's body at the first location and the second transducer comprises a second bone conduction transducer worn by the recipient or implanted on and/or within the recipient's body at the second location.

4. The apparatus of claim 1, wherein the at least one processor comprises a first processor in operative communication with the first transducer and a second processor in operative communication with the second transducer, the first processor and the second processor in operative communication with one another.

5. The apparatus of claim 1, wherein the at least one processor comprises a processor in operative communication with the first transducer and with the second transducer.

6. The apparatus of claim 1, wherein the at least one processor comprises a band stop filter configured to inhibit the first auditory vibrations in the range of vibrational frequencies while not inhibiting the second auditory vibrations in the range of vibrational frequencies.

7. The apparatus of claim 1, wherein the at least one processor comprises a band all-pass filter configured to invert a phase of the first auditory vibrations in the range of vibrational frequencies while not inverting a phase of the second auditory vibrations in the range of vibrational frequencies.

8. The apparatus of claim 7, wherein the at least one processor further comprises gain compensation circuitry configured to adjust a first gain of the first auditory vibrations in the range of vibrational frequencies and/or a second gain of the second auditory vibrations in the range of vibrational frequencies.

9. The apparatus of claim 1, wherein the range of vibrational frequencies is from a first frequency to a second frequency, the first frequency greater than or equal to zero and the second frequency greater than or equal to 200 Hz and less than or equal to 2 kHz.

10. A method comprising:
receiving audio data from a sound source;
generating, in response to the audio data, first control signals configured to control generation of first sound vibrations by a first transducer;
generating, in response to the audio data, second control signals configured to control generation of second sound vibrations by a second transducer spaced from the first transducer;
transmitting the first control signals to the first transducer;
transmitting the second control signals to the second transducer; and
adjusting a gain and/or a phase of the first and/or second sound vibrations in a range of vibrational frequencies to adjust a sound magnitude and/or a sound source location perceived by a recipient of the first and second sound vibrations.

11. The method of claim 10, wherein the first transducer is configured to be in mechanical communication with a first location of a recipient's body and the second transducer is configured to be in mechanical communication with a second location of the recipient's body.

12. The method of claim 11, wherein the first location is closer to a first ear of the recipient's body than to a second ear of the recipient's body and the second location is closer to the second ear than to the first ear.

13. The method of claim 10, wherein said adjusting a gain and/or a phase comprises reducing a gain of the first sound vibrations in the range of vibrational frequencies.

14. The method of claim 13, wherein said reducing the gain of the first sound vibrations comprises reducing the gain of the first sound vibrations to zero across the range of vibrational frequencies.

15. The method of claim 13, wherein said adjusting a gain and/or a phase comprises not adjusting the gain of the second sound vibrations in the range of vibrational frequencies.

16. The method of claim 10, wherein said adjusting a gain and/or a phase comprises adjusting a phase of the first sound vibrations in the range of vibrational frequencies.

17. The method of claim 16, wherein adjusting the phase of the first sound vibrations comprises inverting the phase of the first sound vibrations in the range of vibrational frequencies.

18. The method of claim 10, wherein the range of vibrational frequencies is from a first frequency to a second frequency, the first frequency greater than or equal to zero and the second frequency greater than or equal to 200 Hz and less than or equal to 2 kHz.

19. The method of claim 10, wherein the first transducer and the second transducer are components of a bilateral bone conduction auditory prosthesis and said adjusting a gain and/or a phase is performed during a fitting procedure of the bilateral bone conduction auditory prosthesis to the recipient.

20. A non-transitory computer readable storage medium having stored thereon a computer program that instructs a computer system to adjust a transfer function of at least one bone conduction actuator of a bilateral bone conduction system by at least:
receiving audio data from a sound source;
generating, in response to the audio data, first control signals configured to control generation of first sound vibrations by a first bone conduction actuator;
generating, in response to the audio data, second control signals configured to control generation of second sound vibrations by a second bone conduction actuator spaced from the first bone conduction actuator;
transmitting the first control signals to the first bone conduction actuator;
transmitting the second control signals to the second bone conduction actuator; and
adjusting a gain and/or a phase of the first and/or second sound vibrations in a range of vibrational frequencies to adjust a sound magnitude and/or a sound source location perceived by a recipient of the first and second sound vibrations.

21. The non-transitory computer readable storage medium of claim 20, wherein the first bone conduction actuator is configured to be in mechanical communication with a first location of a recipient's body and the second bone conduction actuator is configured to be in mechanical communication with a second location of the recipient's body.

22. The non-transitory computer readable storage medium of claim 20, wherein the first bone conduction actuator and the second bone conduction actuator are components of a bilateral bone conduction auditory prosthesis and said adjusting a gain and/or a phase is performed during a fitting procedure of the bilateral bone conduction auditory prosthesis to the recipient.

23. A method for fitting an example apparatus to a recipient, the method comprising:
using two bone conduction transducers at two separate locations of the recipient's head to generate and transmit auditory vibrations concurrently to the recipient's two ears, the auditory vibrations indicative of sound to be perceived by the recipient;
adjusting a phase difference in a range of vibrational frequencies between the auditory vibrations from the two bone conduction transducers to increase loudness perceived by the recipient of the auditory vibrations in the range of vibrational frequencies; and
adjusting a gain in the range of vibrational frequencies of the auditory vibrations from at least one of the two bone conduction transducers so that the recipient perceives receiving the sound from a front spatial direction.

24. The method of claim 23, further comprises counteracting an asymmetry in hearing by the recipient's two ears.

25. The method of claim 23, further comprising reducing feedback perceived by the recipient.

26. The method of claim 25, wherein said reducing feedback comprises lowering the gain on the one of the two bone conduction transducers that generates more perceived feedback than the other bone conduction transducer.

27. The method of claim 23, further comprising optimizing for loudness of the perceived sound or for the centeredness of the perceived sound.

28. The method of claim 23, further comprising assessing system performance using pure tone audiometry or synchronized wide band signals.

29. The method of claim 28, wherein said using two bone conduction transducers comprises concurrently generating and transmitting auditory vibrations from the two bone conduction transducers, the auditory vibrations indicative of at least one substantially pure tone and said assessing system performance comprises comparing loudness and/or spatial balance of the sound perceived by the recipient to loudness and/or spatial balance of the sound perceived by the recipient when only a single bone conduction transducer is used to generate and transmit auditory vibrations.
